(19) United States
(12) Patent Application Publication
(10) Pub. No.: US 2024/0361233 A1
(43) Pub. Date: Oct. 31, 2024

(54) METHODS AND SYSTEMS FOR MEASURING OPTICAL CHARACTERISTICS OF OBJECTS

(71) Applicant: University of the Witwatersrand, Johannesburg, Johannesburg (ZA)

(72) Inventors: Tavares Wagner Buono, Johannesburg (ZA); Keshaan Singh, Johannesburg (ZA); Andrew Forbes, Johannesburg (ZA); Angela Dudley, Johannesburg (ZA)

(21) Appl. No.: 18/689,617

(22) PCT Filed: Sep. 7, 2022
(86) PCT No.: PCT/IB2022/058417

§ 371 Date: Mar. 6, 2024

(30) Foreign Application Priority Data
Sep. 7, 2021 (ZA) 2021/06536

(51) Int. Cl. G01N 21/23; G01N 21/21

(52) U.S. Cl. CPC G01N 21/23; G01N 2021/216

(57) ABSTRACT

The invention relates to methods and systems for measuring optical characteristics of objects, particularly for measuring birefringence of objects. The method comprises directing a uniformly polarised measurement beam onto an object: rotating the state of polarisation of the measurement beam automatically with holograms: detecting polarisation properties of the measurement beam without interacting with the object and after interacting with the object for each state of polarisation of the measurement beam; and using the detected polarization properties of the measurement beam without interacting with the object and after interacting with the object for each the state of polarisation to determine a measurement of birefringence of the object.

### FIELD OF THE INVENTION

The invention relates to methods and systems for measuring optical characteristics of objects, particularly for measuring birefringence of objects.

### BACKGROUND TO THE INVENTION

Various instruments and techniques have been used for determining polarisation characteristics of materials. Early polariscopes used reflection on a transparent material to create polarized light that would act as probe for a sample which was then analyzed by another polarizer of the same kind but orthogonally orientated. Any incoming light would be blocked unless its polarization was altered. In this way, by observing though the analyzer, it was possible to see if the sample made any alteration to the polarization of light, and the location where it occurred. Such early devices were improved with the discovery of the polarizing properties of other materials, such as tourmaline and agate, and quickly applied to industry.

The invention of instruments such as the Nicol prism, Wollaston prism and Glan-Thompson prisms enhanced the quality of the observations, as they provided efficient and high-quality sources of polarized light and polarization filtering. The creation of the Laser and phase retarders such as half-wave plates increased the degree of control of the polarization of light, allowing more precise measurements. The high coherency of the Laser made it the perfect tool for precise measurement techniques such as the phase-shifting interferometry.

While the original design of the polariscope remained similar, the discovery of effects such as photoelastic effect and liquid crystal birefringence improved the measurement process in both accurateness and controllability.

Polariscopes have been historically employed in optical metrology, sugar industry and chemical analysis. More recent applications include biology, crystallography and local stress measurements in materials. Their importance rely on not only measuring birefringence, but the spatial distribution of it and the principal axis of optical rotation.

Birefringence has been historically known to be caused by mechanical stress, thermal excitation, Kerr medium excitation and Faraday effect. One effect it causes in light is the change of the state of polarization. When the birefringence is circular (between right- and left-handed circularly polarized light) the observed effect is often called optical activity and/or optical rotation. The observed effect in light is the rotation of state of polarization around an axis in the Poincaré Sphere, where the rotation axis is the same as the axis with birefringence. In material analysis, circular birefringence is associated with chirality in media such as crystals, fibers, thin films and crystallite twisting in banded spherulites.

Some conventional methodologies for measuring birefringence makes use of phase-shifting techniques implemented with mechanical measurement systems. However, these methodologies and/or systems are often time consuming to deploy and require a high degree of accuracy and calibration in their setup in order to achieve accurate measurements of birefringence. In this regard, it is an object of the present invention to provide a means of measuring at least birefringence of materials in a setup which is compact, fast and requires little to no calibration and mechanically moving parts.

### SUMMARY OF THE INVENTION

According to a first aspect of the invention, there is provided a method for measuring an optical characteristic of an object, wherein the method comprises:
directing a uniformly polarised measurement beam onto an object;
rotating the state of polarisation of the measurement beam with holograms;
detecting polarisation properties of the measurement beam without interacting with the object and after interacting with the object for each state of polarisation of the measurement beam; and
using the detected polarization properties of the measurement beam without interacting with the object and after interacting with the object for each the state of polarisation to determine a measurement of at least one optical characteristic of the object.

The method may comprise generating the uniformly polarised beam.

The measurement beam without interaction with the object may be referred to as a reference beam. The reference beam may be the same or a separate beam derived from the measurement beam. Either way, the reference beam, particularly the polarization properties thereof, may correspond substantially with/is identical to/is the same as the measurement beam prior to interaction with the object. In other words, detecting the polarisation properties of the reference beam corresponds substantially to detecting the polarisation properties of the measurement beam without interaction with the object.

The method may comprise deriving and/or obtaining the reference beam from the measurement beam. In a preferred example embodiment, the method may comprise splitting a uniformly polarised beam into two identical beams, wherein one of the beams is the measurement beam which is directed onto the object and the other is the reference beam.

The measurement beam may be a first measurement beam, wherein after rotation of the state of polarisation, the measurement beam may be a further measurement beam.

The method may comprise rotating the state of polarisation of the measurement beam a plurality of times by way of a corresponding number of holograms.

The method may comprise automatically rotating the state of polarisation of the measurement beam a plurality of times by way of holograms. The rotation may be digitally controlled as described herein.

The plurality of times may not be less than thirty.

The method may comprise rotating the state of polarisation of the measurement beam in a sequential fashion.

Differently defined, there is provided a method for measuring an optical characteristic of an object, wherein the method comprises:
a) generating a uniformly polarised initial measurement beam having an initial polarisation state;
b) directing the initial measurement beam onto an object;
c) detecting polarization properties of the initial measurement beam without interacting with the object and after interacting with the object;
d) generating a uniformly polarised subsequent/second measurement beam having a subsequent polarisation state by way of a hologram, wherein the subsequent polarisation state is rotated from the initial polarisation state and/or any preceding polarisation state of the measurement beam by way of the hologram;
e) directing the subsequent measurement beam onto the object;
f) detecting polarization properties of the subsequent measurement beam without interacting with the object and after interacting with the object;
g) repeating steps d) to f) for a predetermined number of times; and
h) using the detected polarization properties of the initial and subsequent/second measurement beams without interacting with the object and after interacting with the object to determine a measurement of at least one optical characteristic of the object.

The predetermined number of times per step g) may be at least thirty. It will be noted that each subsequent measurement beam may have a different rotated state of polarisation from each other and the initial measurement beam. In this way, at least thirty different measurement beams, each with a rotated state of polarisation, is detected both without interacting with the object and after interacting with the object.

The hologram may be configured to interact with a pair of incident light beams to produce a uniformly polarised measurement beam having a predetermined polarisation state. To this end, the hologram may comprise two holograms superimposed and arranged to interact with incident light beams to produce the uniformly polarised subsequent measurement beam having a different polarisation state which is rotated from a polarisation state associated with a preceding measurement beam. The hologram may comprise a plurality of superimposed holograms. The hologram may comprise two spatial gratings.

The method may comprise providing the hologram to interact with incident light beams from a light source to generate the measurement beams in a computer-controlled fashion by way of a digitally controlled phase/polarisation sensitive device. The phase/polarisation sensitive device may be a digital micromirror device (DMD).

The method may comprise detecting the polarisation properties of the measurement beams after interaction/interacting with the object in order to generate polarization measurement values, wherein the polarization measurement values represent output polarization states of the measurement beams, after interaction/interacting with the object.

The method may comprise detecting the polarisation properties of the measurement beams without interaction/interacting with the object in order to generate polarization reference values, wherein the polarization reference values represent output polarization states of the measurement beams without interaction/interacting with the object. In other words, the polarisation reference values represent output polarisation states of the measurement beams prior to interaction with the object.

The optical characteristic of the object being measured may be birefringence of the object. In this way, the method may comprise evaluating the polarization measurement values and polarization reference values, to determine at least one birefringence parameter representing the birefringence of the object. The birefringence parameter may be representative of an amount of birefringence of the object and may be calculated through numerical fitting with minimal error using the polarisation measurement values and polarisation reference values.

The method may comprise detecting the polarisation properties of the measurement beams with at least one suitable photodetector device. The method may comprise detecting the polarisation properties of the reference beams with the same photodetector device used to detect polarisation properties of the measurement beams. However, the method may comprise detecting the polarisation properties of the reference beams with a separate suitable photodetector device. In one example embodiment, the photodetector devices described herein may be in the form of charge coupled device (CCD) camera/s having a plurality of pixels. In this regard, the polarisation measurement values and/or polarisation reference values may be associated with intensity values for each pixel in an image captured by the photodetector device/s.

The method may comprise generating the initial measurement beam by way of an initial hologram, wherein the subsequent measurement beams are generated by way of subsequent holograms. The method may comprise changing the initial hologram to the subsequent hologram; and changing the subsequent holograms in a digital and/or computer-controlled manner to rotate the state of polarisation of the measurement beam prior to interacting with the object.

The method may comprise providing the initial and subsequent holograms to interact with incident light beams from a light source to generate the measurement beams.

The method may comprise providing the holograms to the incident light beams at a predetermined timed intervals in a sequential fashion automatically. The measurement and/or the reference beams are thus generated at predetermined timed intervals in a sequential fashion automatically. To this end, the method may comprise providing the holograms to the incident light beams in a computer-controlled fashion by way of a digitally controlled phase/polarisation sensitive device. The phase/polarisation sensitive device may be a digital micromirror device (DMD). In this way, the holograms may be switched automatically by the DMD in a relatively fast manner. In this way, the need for measuring birefringence using mechanically rotating parts is obviated as the polarisation of the measurement beam is rotated by holograms which are controlled digitally. The predetermined time intervals may be approximately one second. However, nothing precludes the time intervals from being less than one second and more than one second.

The method may comprise controlling the DMD to switch providing the holograms at the predetermined time intervals. It follows that the method may comprise switching the holograms within one second. In this way, the polarisation state of the measurement beam may be rotated in a relatively short period of time as there is no need to mechanically rotate the polarisation state of the measurement beam.

The method may comprise splitting a light beam from a light source into two paths; providing the DMD to interact with the two paths, wherein the two paths interact with the DMD with an angular offset relative to each other. The method may comprise splitting the light beam into two differently polarised beams/two different polarisation components with each beam travelling in one of the two paths. This may be done via a half wave plate and/or a polarizing beam splitter. The angular offset between the two polarisation paths may be approximately 1.5° before interacting with the DMD. It will be appreciated that other angles may be used but a higher resolution DMD is required for larger angular offsets, particularly a high-resolution display of the DMD. The objective of the offset is to create the two beams that propagate in directions X and Y which differ only by a small angle.

Each hologram may each comprise a hologram which interacts with one polarised beam, and another superimposed hologram which interacts with the other differently polarised beam thereby to modulate both polarised beams to make first diffraction orders of both polarised beams come out of the hologram together with uniform polarisation.

Those skilled in the field of invention would appreciate that the reference to the “DMD” means reference to the holograms provided thereby and thus, unless indicated or obvious to those skilled in the art, reference to the DMD means reference to the holograms provided by the DMD.

The measurement beams may have Gaussian amplitude profiles with an induced phase difference therebetween. The phase difference is due to the interaction with the holograms. The method may comprise providing at least thirty holograms in the manner described herein to result in thirty measurement beams, each having a rotated state of polarisation from each other.

The beams arriving at the DMD may be vertically and horizontally polarised light beams travelling in the two paths which interact with the holograms provided by the DMD to yield the uniformly polarised measurement beams. In particular, only the first diffraction orders of the vertical and horizontally polarised beams after interaction with the holograms are used as the measurement beams. The holograms may each comprise a hologram which interacts with the vertically polarised beam, and another superimposed hologram which interacts with the horizontally polarised beam thereby to modulate both polarised beams to make first diffraction orders of both polarised beams come out of the hologram together with uniform polarisation.

The light source may be in the form of a laser, wherein the method comprises expanding and collimating the light beam from the laser prior to splitting the same into the two paths.

The method may comprise directing the measurement beams through a first polarising element prior to interacting with the object. The polarising element may be in the form of a quarter wave plate.

The method may comprise directing the measurement beams through a second polarising element after interacting with the object. The polarising element may be in the form of a linear polariser, or a polarizing beam splitter.

The method may comprise storing the detected polarization properties associated with the measurement beams without interacting with the object and after interacting with the object in a suitable memory device for processing to determine the measurement of at least one optical characteristic of the object.

The method may comprise directing the measurement beams through one or more Fourier imaging systems before directing the measurement beam to the photodetector device.

According to another aspect of the invention, there is provided a system for measuring an optical characteristic of an object, wherein the system comprises:
a beam generating arrangement comprising a holographic device, wherein the beam generating arrangement is configured to generate and direct a uniformly polarised measurement beam onto an object, wherein the holographic device is configured to rotate a state of polarisation of the measurement beam with holograms;
a detector arrangement configured to detect polarisation properties of the measurement beam without interacting with the object and after interacting with the object for each the state of polarisation of the measurement beam; and
a processor configured to use the detected polarization properties of the measurement beams without interacting with the object and after interacting with the object for each state of polarisation of the measurement beams to determine a measurement of at least one optical characteristic of the object.

The measurement beam may be an initial measurement beam, wherein after rotation of the state of polarisation, the measurement beam may be a subsequent measurement beam. The measurement beam without interacting with the object may be a reference beam.

The beam generating arrangement may be configured to generate a uniformly polarised initial measurement beam having an initial polarisation state; and generate a plurality of uniformly polarised subsequent measurement beams having subsequent polarisation states by way of holograms provided by the holographic device. As alluded to herein, the subsequent polarisation states are rotated from each other and/or the initial polarisation state by way of the holograms.

The detector arrangement may comprise a photosensitive detector device such as a CCD camera configured to detect polarization properties of the measurement beams without interacting with the object and after interacting with the object.

The system may comprise a plurality of optical elements to direct the measurement beams onto the object, and to the detector device. In other words, the optical elements may be provided to direct the measurement beams through the object and onto the detector device. Similarly, in some example embodiments, the system may comprise a plurality of optical elements to direct the measurement beams without interacting with the object, viz. reference beams, to the detector device. The optical elements as described herein may be part of the detector arrangement in some example embodiments.

The processor may be configured to use the detected polarization properties of the initial and subsequent measurement beams after interaction with the object to determine the measurement of at least one optical characteristic of the object.

Each hologram provided by the holographic device may comprise two holograms superimposed and arranged to interact with incident light beams to produce the uniformly polarised measurement beams having the polarisation states which are rotated from each other.

The beam generating arrangement may comprise a light source. The light source may be a laser light source. The holographic device may be configured to provide the holograms to interact with incident light beams from a light source to generate the measurement beams in a computer-controlled/electronic/digital fashion. The holographic device may be a digital micromirror device (DMD).

The detector may be configured to detect the polarisation properties of the measurement beams after interaction with the object in order to generate polarization measurement values, respectively, wherein the polarization measurement values represent output polarization states of the measurement beams after interaction with the object.

In some example embodiments, the detector may be configured to detect the polarisation properties of the measurement beams without interacting with the object in order to generate polarization reference values, wherein the polarization reference values represent output polarization states of the measurement beams without interacting with the object.

It will be noted that in some example embodiments, the system may comprise a reference detector configured to detect the polarisation properties of the measurement beams without interacting with the object in order to generate the polarisation reference values. The system may therefore comprise a suitable beam splitting arrangement configured to split the measurement beam into two paths, one directed to intersect with the object and detector, and the other direct to the reference detector. The polarisation reference values should be identical to the measurement beam prior to interaction with the object.

The reference detector may be substantially similar to the detector.

The optical characteristic of the object being measured may be birefringence of the object. In this way, the processor is configured to evaluate the polarization measurement and the reference values, to determine at least one birefringence parameter representing the birefringence of the object. The birefringence parameter may be representative of an amount of birefringence of the object and the processor may be configured to use the polarisation measurement values and reference values for each state of polarisation to calculate the birefringence parameter. This may be done through a numerical fitting technique with minimal error.

The CCD camera may have a plurality of pixels, wherein the polarisation measurement values and/or reference values may be associated with intensity values for each pixel in an image captured by the photodetector device. In other words, the polarisation measurement values may be intensities of the measurement beams and/or reference beams detected by the CCD camera.

The holographic device may be configured to provide different holograms to generate the initial and subsequent measurement beams. In particular, the holographic device may be configured to provide the holograms to interact with incident light beams from the light source to generate the measurement beams.

The holographic device may be configured to provide to the incident light beams at a predetermined timed intervals in a sequential fashion automatically. The measurement and/or the reference beams are thus generated at predetermined timed intervals in a sequential fashion automatically. To this end, the method may comprise providing the holograms to the incident light beams in a computer-controlled fashion by way of a digitally controlled phase/polarisation sensitive device. The phase/polarisation sensitive device may be a digital micromirror device (DMD). In this way, the holograms may be switched automatically by the DMD in a relatively fast manner. In this way, the need for measuring birefringence using mechanically rotating parts is obviated as the polarisation of the measurement beam is rotated by holograms which are controlled digitally. The predetermined time intervals may be approximately one second. However, nothing precludes the time intervals from being less than one second and more than one second.

The beam generating arrangement may comprise a suitable beam splitter to split the light beam from a light source into two paths. The holographic device may be located downstream from the light source and may intersect with the two paths so that the light beams travelling in the two paths both intersect with the holographic device. The light beams travelling in the two paths may be differently polarised beams/have two different polarisation components. The beam generating arrangement may comprise a half wave plate and/or a polarizing beam splitter to split the light beam from the light source into the two polarised beams. The two paths may intersect at the holographic device with an angle. The angle may be approximately 1.5°.

Each hologram may comprise a hologram which interacts with one polarised beam, and another superimposed hologram which interacts with the other differently polarised beam thereby to modulate both polarised beams to make first diffraction orders of both polarised beams come out of the hologram together with uniform polarisation. In other words, the holograms may be multiplexed holograms.

Those skilled in the field of invention would appreciate that the reference to the “DMD” or “holographic device” means reference to the holograms provided thereby and thus, unless indicated or obvious to those skilled in the art, reference to the DMD or holographic device means reference to the holograms provided by the DMD or holographic device.

The measurement beams may have Gaussian amplitude profiles with an induced phase difference between the different measurement beams. The phase difference is due to the interaction with the holograms.

The beams arriving at the holographic device may be vertically and horizontally polarised light beams travelling in the two paths which interact with the holograms provided by the holographic device to yield the uniformly polarised measurement beams.

Only first diffraction orders of the differently polarised beams in the two paths after interaction with the holograms are used as the measurement beams. In particular, the holograms may each comprise a hologram which interacts with one polarised beam, for example, the vertically polarised beam and another superimposed or multiplexed hologram which interacts with the other differently polarised beam, for example, the horizontally polarised beam to modulate both polarised beams to make first diffraction orders of both polarised beams come out of interacting with the hologram together with uniform polarisation. In other words, the holograms acting on the beams of different polarisation states in the first and second paths permit first diffraction orders of the incident beams to spatially overlap.

In this regard, the system may comprise a suitable aperture to spatially filter the measurement beam from the holographic device.

The beam generating arrangement may comprise suitable optical components to expand and collimate the light beam from the laser prior to splitting the same into the two paths.

The system may comprise a first polarising element located downstream from the holographic device and upstream from the object. The polarising element may be in the form of a quarter wave plate.

The system may comprise a second polarising element located downstream from the object. The polarising element may be in the form of a linear polariser, or a polarizing beam splitter.

The system may comprise a suitable memory device configured to store the detected polarization properties associated with the measurement beams in a suitable memory device for processing to determine the measurement of at least one optical characteristic of the object.

### BRIEF DESCRIPTION OF THE FIGURES

Non-limiting embodiments of the invention will now be described by way of example only and with reference to the following Figures:

FIG. 1 shows a high-level schematic block diagram of a system for measuring an optical characteristic, particularly birefringence, of an object in accordance with an example embodiment of the invention;

FIG. 2 shows a detailed illustration of an example system for measuring an optical characteristic, particularly birefringence, of an object in accordance with an example embodiment of the invention;

FIG. 3 shows a detailed illustration of another example system for measuring an optical characteristic, particularly birefringence, of an object in accordance with an example embodiment of the invention;

FIG. 4 shows a high-level block flow diagram of a method for measuring an optical characteristic, particularly birefringence, of an object in accordance with an example embodiment of the invention;

FIG. 5 shows a diagram illustrating how the measured intensity of a diagonally polarized projection change with and without passing through a birefringent material as the phase difference between the generating components is changed; and

FIG. 6 shows images illustrating the phase difference between the right and left circularly polarised components induced by a liquid crystal q-plate (a) and alanine crystals (b); and images illustrating the phase difference between the vertically and horizontally polarised components induced by a metasurface q-plate (c) and j-plates (d) and (e).

### DESCRIPTION OF PREFERRED EMBODIMENTS

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible, and may even be desirable in certain circumstances, and are a part of the present invention. Thus, the following description is provided as illustrative of the principles of the present invention and not a limitation thereof.

It will be appreciated that the phrase “for example,” “such as”, and variants thereof describe non-limiting embodiments of the presently disclosed subject matter. Reference in the specification to “one example embodiment”, “another example embodiment”, “some example embodiment”, or variants thereof means that a particular feature, structure or characteristic described in connection with the embodiment(s) is included in at least one embodiment of the presently disclosed subject matter. Thus, the use of the phrase “one example embodiment”, “another example embodiment”, “some example embodiment”, or variants thereof does not necessarily refer to the same embodiment(s).

Unless otherwise stated, some features of the subject matter described herein, which are, described in the context of separate embodiments for purposes of clarity, may also be provided in combination in a single embodiment. Similarly, various features of the subject matter disclosed herein which are described in the context of a single embodiment may also be provided separately or in any suitable sub-combination.

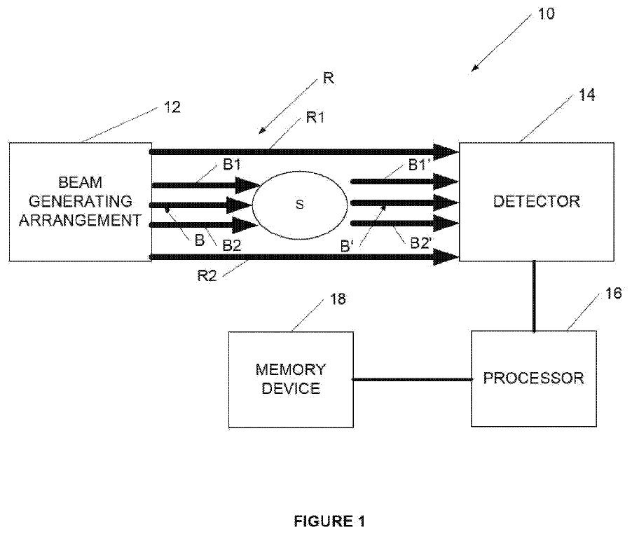

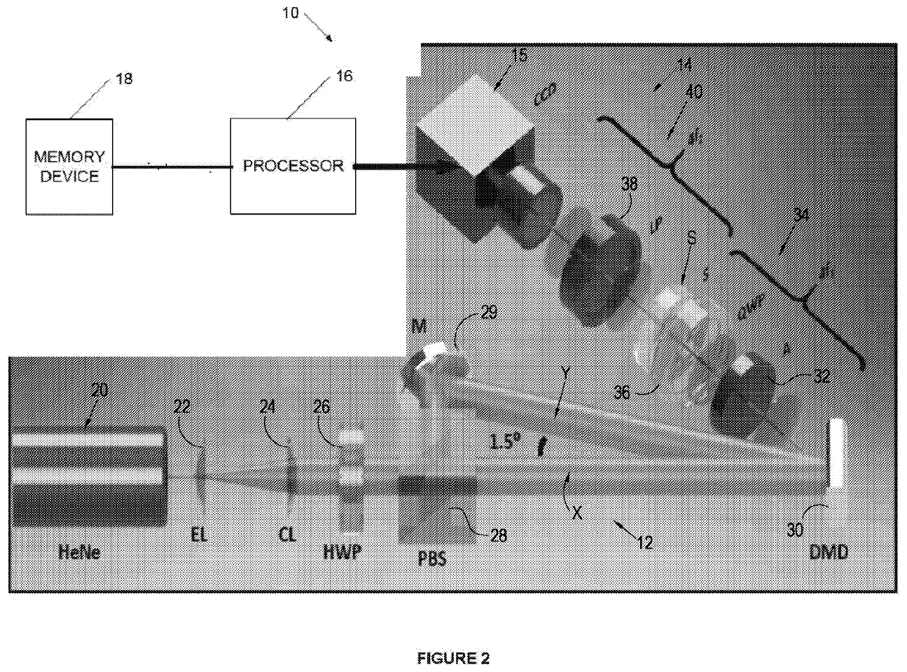

Referring to FIGS. 1 and 2 of the drawings, a system for measuring an optical characteristic of an object, particularly birefringence of an object S is generally indicated by reference numeral 10. The system 10 may therefore be referred to as a birefringence measurement system 10. The system 10 is configured to employ holograms to rotate a polarisation state of a measurement beam B for the purpose for measuring birefringence of the object S as described herein. The object S may be a sample of a target material having optical characteristics and whose birefringence properties are to be measured by the system 10. The birefringence measured by the system 10 described herein may be linear and/or circular birefringence.

Though the optical characteristic of birefringence is measured with the system and methodologies described herein, it will be understood by those skilled in the art that other optical characteristics of objects may be determined or measured by the system and methodologies described herein, mutatis mutandis.

In any event, a theoretical explanation of the principles of operation of the system 10 and the methodology for measuring birefringence of an object S as disclosed herein follows below before a detailed explanation.

### Theoretical Description

Consider a field U(\vec{r}) (with \vec{r}=(x,y)) in some general elliptical polarization state described by the Stokes vector:

$$Ψ = U ( \vec{r} ) ( \begin{matrix}1 \\ cos 2 α cos 2 ϕ \\ cos 2 α sin 2 ϕ \\ sin 2 α\end{matrix} ) \qquad ( 1 )$$

where α describes the relative weighting of right and left circularly polarized (|R [symbol] and |L [symbol] ) components and ϕ describes the phase difference between these components according to:

$$Ψ = U ( \vec{r} ) ( cos ( \frac{α}{2} ) {e}^{i ϕ} \vert R 〉 + sin ( \frac{α}{2} ) {e}^{- i ϕ} \vert L 〉 ) . \qquad ( 2 )$$

Now considering passing this state through a linear polarizer with its transmission axis at 45° to the horizontal, one may use the Mueller matrix of the polarizer to operate on the state to obtain:

$${Ψ}^{′} = U ( \vec{r} ) ( \begin{matrix}1 & 0 & 1 & 0 \\ 0 & 0 & 0 & 0 \\ 1 & 0 & 1 & 0 \\ 0 & 0 & 0 & 1\end{matrix} ) ( \begin{matrix}1 \\ cos 2 α cos 2 ϕ \\ cos 2 α sin 2 ϕ \\ sin 2 α\end{matrix} ) = U ( \vec{r} ) ( \begin{matrix}1 + cos 2 α sin 2 ϕ \\ 0 \\ 1 + cos 2 α sin 2 ϕ \\ sin 2 α\end{matrix} ) . \qquad ( 3 )$$

Considering the total intensity (i.e., Ψ₁₁=S₀), one may note that the case of equal weightings (α=π/2) results in intensity patterns that will produce cosine curves dependent on ϕ, whereas the case of no phase difference between polarization components (ϕ=0) will depend on α, as in

$$\begin{matrix}{Ψ}_{11}^{′} = α = \frac{π}{2} ) = U ( \vec{r} ) ( 1 - cos ( \frac{π}{2} - 2 ϕ ) ) , & ( 4 ) \\ {Ψ}_{11}^{′} ( ϕ = \frac{π}{4} ) = U ( \vec{r} ) ( 1 + cos 2 α ) . & ( 5 )\end{matrix}$$

Now, when placing a general elliptical retarder before the polarizer, where the variables β and γ characterise the respective linear retardance (phase difference between horizontal and vertical polarization components) and optical rotation (rotation of linear polarization due to the phase difference, 2γ, between right and left circular polarization components). One gets an output Stokes vector Ψ^{o} according to:

$$\begin{matrix}{Ψ}^{o} = U ( \vec{r} ) ( \begin{matrix}1 & 0 & 1 & 0 \\ 0 & 0 & 0 & 0 \\ 1 & 0 & 1 & 0 \\ 0 & 0 & 0 & 1\end{matrix} ) ( \begin{matrix}1 & 0 & 0 & 0 \\ 0 & cos 2 γ {sin}^{2} \frac{β}{2} + {cos}^{2} \frac{β}{2} & sin 2 γ {sin}^{2} \frac{β}{2} & - sin γ sin β \\ 0 & sin 2 γ {sin}^{2} \frac{β}{2} & - cos 2 γ {sin}^{2} \frac{β}{2} + {cos}^{2} \frac{β}{2} & cos γ sin β \\ 0 & sin γ sin β & - cos γ sin β & cos β\end{matrix} ) ( \begin{matrix}1 \\ cos 2 α cos 2 ϕ ) \\ cos 2 α sin 2 ϕ \\ sin 2 α\end{matrix} ) \\ = U ( \vec{r} ) ( \begin{matrix}1 + cos 2 α sin 2 ϕ ( {cos}^{2} \frac{β}{2} + cos 2 γ {sin}^{2} \frac{β}{2} ) - sin 2 α sin β cos γ + cos 2 α {sin}^{2} \frac{β}{2} sin 2 γ cos 2 ϕ \\ 0 \\ 1 + cos 2 α sin 2 ϕ ( {cos}^{2} \frac{β}{2} + cos 2 γ {sin}^{2} \frac{β}{2} ) - sin 2 α sin β cos γ + cos 2 α {sin}^{2} \frac{β}{2} sin 2 γ cos 2 ϕ \\ cos β sin 2 α + cos 2 α cos 2 ϕ sin β sin γ - cos 2 α cos γ sin β sin 2 ϕ .\end{matrix} )\end{matrix} \qquad ( 6 )$$

Here, if one considers a fixed β=π together with the previous (α=π/2) one gets:

$${Ψ}_{11}^{o} ( α = \frac{π}{2} , β = π ) = U ( \vec{r} ) ( 1 - cos ( \frac{π}{2} - ( 2 ϕ + 2 γ ) ) ) \qquad ( 7 )$$

While if one considers fixing γ=π/2 and ϕ=0 one obtains:

$${Ψ}_{11}^{o} ( ϕ = \frac{π}{4} , γ = \frac{π}{4} ) = U ( \vec{r} ) ( 1 + cos ( 2 α - β ) ) \qquad ( 8 )$$

The situations considered above describe the following behaviour, in the case of fixing α=π/2 one is considering a linearly polarized scalar field whose polarization axis is rotating with ϕ (Eqn. 4) resulting in the cosine behaviour of the intensity when passed through the diagonal polarizer. Then, when a circularly birefringent material is placed before the polarizer, the induced optical rotation will proportionally shift the cosine curve (Eqn. 7). When considering ϕ=π/4 as fixed, the polarization state of the scalar beam rotates around the meridian of the Poincare sphere with changing α (i.e., accessing the circularly and ±45° linearly polarized states as well as all the intermediate elliptical states—Eqn. 5), resulting in the same cosine intensity change with α. When a sample exhibiting linear birefringence is introduced the cosine curve is shifted proportionally (Eqn. 8).

Thus, it follows that by varying either α or ϕ and measuring the intensity of the 45° projection after travelling through a sample exhibiting either linear or circular birefringence respectively, the linear retardation (or optical rotation angle γ can be determined through fitting the measured intensities to Eqns. 8 and 7.

### Practical Description

It will be appreciated that the system 10, as contemplated herein, is configured to employ the above principles to determine a measure of birefringence of the object S. To this end, the system 10 comprises a beam generating arrangement 12 configured to generate a uniformly polarised measurement beam B and rotate a state of polarisation thereof for predetermined number of times in a successive and/or sequential fashion. In this way, a plurality of beams with different states of polarisation is generated by the beam generating arrangement 12.

For a single rotation of the measurement beam as contemplated herein, the beam generating arrangement 12 is configured to generate: an initial or first measurement beam B1; and a subsequent or second measurement beam B2 with a rotated polarisation state from the first measurement beam B1. This may be one iteration of a rotation contemplated herein of the beam B by the beam generating arrangement 12. It will be understood by those skilled in the art that the beam generating arrangement 12 is further configured to generate one or more subsequent beams Bn (n=3 . . . . N), or further second beams B2 (not shown), each being rotated from a preceding measurement beam. The beam generating arrangement 12 may be configured to generate a plurality of subsequent measurement beams Bn, wherein each subsequent measurement beam Bn has a polarisation state rotated from an immediately preceding measurement beam Bn. The beam generating arrangement 12 may be configured to generate a plurality of subsequent measurement beams Bn for a predetermined number of iterations N in a successive or sequential fashion in a similar manner as described herein with the rotation of the polarisation state of the initial or first measurement beam to the different polarisation state of the subsequent or second measurement beam B2. Instead, or in addition, the beam generating arrangement 12 may be configured to generate a plurality of subsequent measurement beams Bn for a number of iterations N which enables the system 10 to determine or measure birefringence of the object S. The number of iterations N may be a minimum of thirty. It will be noted that the term “rotated” in relation to the beam B may be understood to mean a “rotated state of polarisation” or “rotated polarisation state”, where applicable, those skilled in the art will appreciated that these terms may be used in an interchangeable fashion.

The system 10 also comprises a detector arrangement 14 downstream from the beam generating arrangement 12 to detect the beam B′ after it has interacted with the object S. By “detecting” the beam B′ after interacting with the object S, it will be appreciated that the detector arrangement may be configured to measure the intensity/intensities of one or more beams B′ after interaction with the object S.

The system 10 further comprises a processor 16 electrically/communicatively coupled to the detector arrangement 14 and a memory device 18, wherein the processor 16 is configured to use detected/received/measured intensities of the beam B′ from the detector arrangement 14 to determine a measurement of birefringence, for example, by fitting the measured intensities to Eqns. 8 and 7 depending on whether the sample is linearly or circularly birefringent, respectively, as described herein.

The detector arrangement 14 is also configured to detect the beam B without interaction with the sample or object S as a reference beam R. The reference beam R is effectively identical to/substantially similar/the same as the beam B from the arrangement 12 prior to interacting with the sample S.

The detector arrangement 14 comprises a CCD camera 15 which comprises a plurality of pixels which are responsive to the measurement beam B in a conventional fashion. In particular, the CCD 15 measures or detects polarisation intensities associated with the measurement beam. Referring also to FIG. 5 of the drawings, a plot of polarisation intensities of the measurement beam B measured/detected by the CCD 15 with no object S present, in other words the reference beam R, is indicated by reference numeral 70 and has a cosine profile. The plot of polarisation intensities of the measurement beam B after interacting with the sample S is indicated by reference numeral 72. Like the plot 70, the plot 72 also has a cosine profile but is shifted from the plot 70 as illustrated due to an induced phase difference.

The detector arrangement 14 and/or the system 10 further comprises optical systems/components which facilitate directing the measurement beam B through the object S and onto the CCD camera 15.

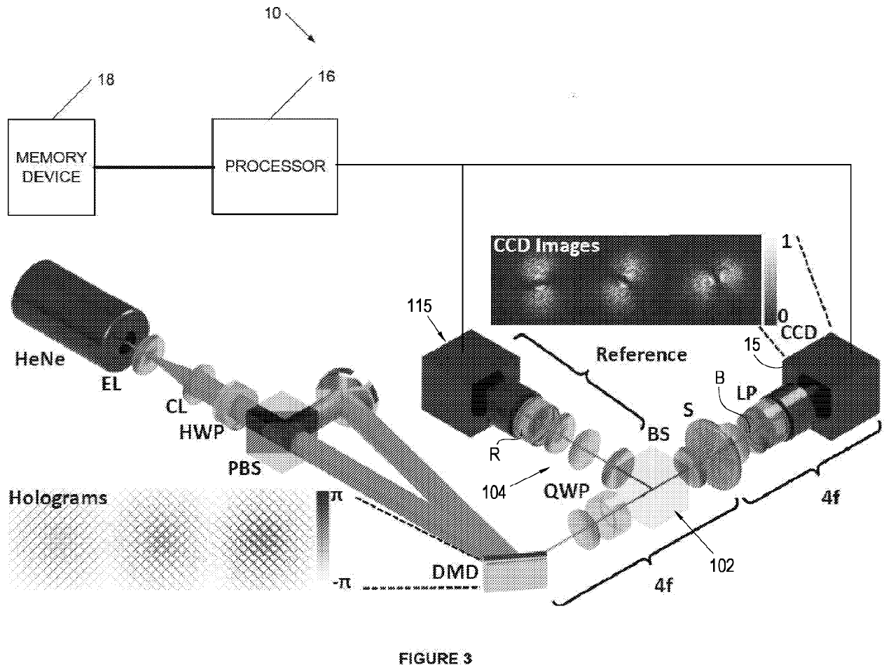

Referring to FIG. 3 of the drawings, another example embodiment of a system in accordance with an example embodiment is generally indicated by reference numeral 100. It will be understood to those skilled in the art that the system 100 is substantially similar to the system 10 and similar components will be labelled with the same reference numerals where necessary. The system 100 has an additional beam splitter 102, focusing optics 104, and additional reference detector 115 in a reference optical path which effectively enables the system 100 to detect the measurement beam B without interacting with the object S, or in other words, the reference beam R. To this end, the beams splitter 102 splits the measurement beam as previously described into: i) the measurement beam B which actually interacts/intersects with the object S; and ii) the reference beam R which does not interact with the object S. In this way, the system 100 may be used for objects S which are too large for the measurement beam B to pass therethrough and strike the detector 15 as well as simultaneously strike the detector 15 without interacting with the sample S (to provide the reference beam R). This is because the reference beam R, which corresponds to the measurement beam B without interacting with the object, is detected separately by the detector 115 which is communicatively coupled to the processor 16 and the memory device 18.

From the foregoing, it will be appreciated that the system 10 and 100 are effectively arranged to detect intensities of the measurement beams B after interacting with the sample S and without interacting with the sample, the latter being the reference beam R referred to herein.

Reference will hereinafter be with reference to system 10 but those skilled in the art will appreciated that the same comments and description may be applicable to the system 100.

The processor 16 is electrically coupled to the CCD 15 to receive intensity values, or data/signals representative of the intensities detected or measured by the CCD 15. The processor 16 may typically be one or a combination of microcontrollers, processors, graphics processors, or field programmable gate arrays (FPGAs) operable to achieve the desired operation as described herein. The processor 16 may be operable under instructions stored in an internal memory or external memory device 18 to perform the operations described herein. In particular, the processor 22 is configured to receive intensity values, or data indicative thereof, from the CCD 15 and use the same as an input to determine a measurement of birefringence of the object S.

The system 10 may further comprise an output module (not shown), in the form of a display, for example, an LCD (Liquid Crystal Display), Light Emitting Diode (LED) screen, CRT (Cathode Ray Tube) screen, printer, or the like, communicatively coupled to the processor 16 to output the measured birefringence. In alternate example embodiments, the output module may be in the form of an audible output, this may, for example, be a speaker used to audibly output the measured birefringence.

It will be understood by those skilled in the field of invention that the processor 16, memory device 18 and the output module need not be in close proximity to the CCD 15, 115 to receive signals indicative of the intensities therefrom. Though not illustrated, the system 10 comprises associated biasing and/or driving circuitry, and a power source, for operating the electrically driven and/or controlled components of the system. Similarly, the system 10 may comprise suitable optical elements such as mirrors, and the like for manipulating light in the system 10 in a desired fashion as will be described below.

The beam generating arrangement 12 may be better seen from FIG. 2, wherein the arrangement 12 comprises a light source in the form of a laser 20, for example, a 633 nm HeNe Laser. The beam generating arrangement 12 further comprises lenses EL 22 (f=2 mm) and CL 24 (f=200 mm) which are configured to expand and collimate the beam from the laser 20, respectively.

The beam generating arrangement 12 further comprises a half-wave plate (HWP) 26 located downstream from the lens 24 to control the plane of polarisation and a polarization prism or polarization separation element such as a polarization beam splitter (PBS), a Wollaston prism, or the like 28 and an associated mirror (M) 29 configured to split the beam received from the HWP 26 into two differently polarised beams which travel in two paths X and Y. It will be noted that the beams travelling in path X and Y with different polarisations may herein be referred to as two polarisation components. In the present example embodiment, a horizontally polarised beam travels in path X and a vertically polarised beam travels in path Y. The polarised beams travelling in the paths X and Y may be orthogonally polarised with respect to each other.

The beam generating arrangement 12 advantageously comprises a polarisation sensitive holographic device in the form of a digital mirror device (DMD) 30 which is configured to intersect the paths X and Y, with an angular offset between the paths X and Y of approximately 1.5°. The paths X and Y are aligned so that the horizontally and vertically polarised beams (have a central region of approximately constant amplitude) intersect at the DMD 30. The DMD 30 is addressed by two multiplexed holograms (A and B).

The DMD 30 is configured to provide a first multiplexed hologram to the intersecting beams from paths X and Y to generate a first measurement beam B1 with a first polarisation state. The DMD 30 is further configured to switch from providing the first multiplexed hologram to the beams from paths X and Y to providing a second multiplexed hologram thereby to generate a second measurement beam B2 which has its polarisation state rotated from the first measurement beam B1 and/or each other. As alluded to above, the DMD 30 may be configured to provide multiplexed holograms to the incident beams to generate further measurement beams Bn, each having a polarisation state rotated from an immediately preceding measurement beam Bn−1. This may be achieved in a computer-controlled/digital/electronic fashion wherein the DMD 30 is controlled to be addressed by the holograms, particularly the first hologram and then the second hologram in a relatively fast manner. In other words, the DMD 30 is configured to rotate the polarisation of the measurement beam B by being addressed by suitable hologram/s which facilitate said rotation of polarisation. The holograms may achieve this by interacting on the phase of the incoming beams.

It will be understood by those skilled in the art that the terminology that the DMD 30 is “addressed” by holograms may be used interchangeably with the DMD “providing” the holograms. The DMD 30 may be understood to, electronically/in a computer-controlled fashion, change the holograms provided thereby which interact with the two light beams from the light source as described above thereby to change the state of polarisation of the resultant measurement beam B.

In any event, the system 10 comprises an aperture (A) 32 located downstream from the DMD 30 to spatially filter the overlapped diffraction order of the beam from the DMD 30. The system 10 further comprises a first 4f Fourier imaging system 34 to image the spatially filtered beam B with overlapped diffraction order onto the object S.

The system 10 may also comprise a quarter-wave plate (QWP) 36, upstream from the object S and downstream from the first Fourier imaging system 34, which is configured to convert the horizontal and vertical polarization components to right and left circular polarisation respectively, if necessary. It will be understood that the QWP 36 may be removed depending on whether or not linear or circular birefringence is being measured.

The system 10 may comprise a diagonally orientated linear polarizer (LP) 38 located downstream from the object S and a second 4f Fourier imaging system 40 to image the measurement beam B after traveling through the sample onto the detector arrangement 14.

Each multiplexed hologram provided by the DMD 30 comprises two superimposed or multiplexed hologram (A and B) which may be defined by the following function:

$${H}_{A / B} = \frac{1}{2} + \frac{1}{2} ( cos ( 2 π ( {n}_{x}^{A / B} x + {n}_{y}^{A / B} y ) + {πφ}^{A / B} ) - cos ( arcsin ( {e}^{- \frac{{x}^{2} + {y}^{2}}{{w}_{0}^{2}}} ) ) ) , , \qquad ( 9 )$$

where a Gaussian amplitude profile was chosen and φ^{A/B} is an induced phased difference. The spatial carrier frequencies (n_{x/y}^{A/B}) of the gratings are adjusted so that the +1 diffraction orders of HA from the horizontal component and H_{B} from the vertical component spatially overlap. The DMD 30 effectively combines the beams from the two paths X and Y to provide a single measurement beam B.

The beams generated using this setup (with and without the QWP) may be described as:

$$\begin{matrix}Ψ ( wo / QWP ) = {e}^{- \frac{{x}^{2} + {y}^{2}}{{w0}^{2}}} ( \vert H 〉 + {e}^{i φ} \vert V 〉 ) = ( \begin{matrix}1 \\ 0 \\ cos 2 φ \\ sin 2 φ\end{matrix} ) , & ( 10 ) \\ Ψ ( w / QWP ) = {e}^{- \frac{{x}^{2} + {y}^{2}}{w {0}^{2}}} ( \vert R 〉 + {e}^{i φ} \vert L 〉 ) = ( \begin{matrix}1 \\ cos 2 φ \\ sin 2 φ \\ 0\end{matrix} ) , & ( 11 )\end{matrix}$$

where φ=φB−φA. Therefore as-is varied holographically by the switching of the first and second holograms, the intensity measured by the CCD 15 varies according to Eqs 5 and 4—where φ=2γ and φ=β with and without the QWP 36 respectively.

In some example embodiments, the system 10 as described herein may be packaged in a suitable housing with a suitable receptacle for objects S.

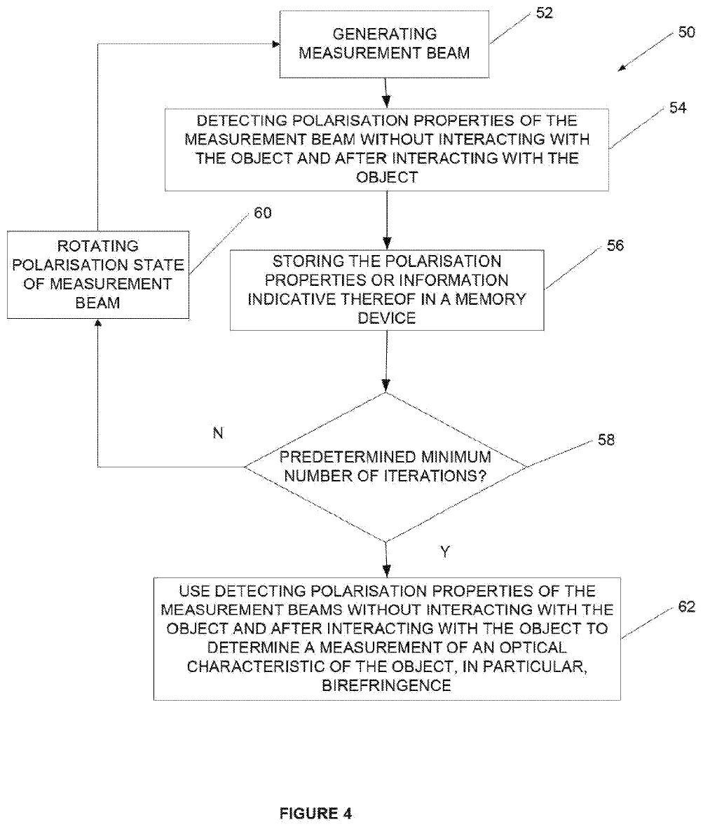

Referring to FIG. 4 of the drawings, a flow diagram of a method for measuring an optical characteristic of an object S, typically measuring birefringence of the object S in accordance with an example embodiment of the invention is generally indicated by reference numeral 50. The method 50 is typically carried out by the system 10, 100 as described herein and thus the description which follows is on this basis. However, it will be appreciated that the method 50 may be carried out by other systems, not illustrated herein.

The object S, which may be a sample, is typically located in the path of the measurement beam between the DMD 30 and the CCD 15 as illustrated in FIG. 2 to intersect with the measurement beam B.

The method 50 will be described with reference to two iterations of the measurement beams, B1 and B2, interacting with the sample S. However, the methodology described herein may be repeated multiple times for a minimum of thirty iterations as will be described below.

The method 50 comprises generating, at block 52, a uniformly polarised measurement beam, for example, the initial or first measurement beam B1 having a first polarisation state and directing the same to the sample S. This may be achieved by expanding and collimating the beam from the laser 20 before splitting the same into two differently polarised beams, for example, horizontally and vertically polarised beams in paths X and Y and directing the two differently polarised beams in the paths X and Y onto the DMD 30 addressed with the first hologram.

The measurement beam B1 is spatially filtered by the aperture 32 and directed at block 54, towards the object S. This may be via the first Fourier system 34. Moreover, depending on whether circular or linear birefringence is being measured, the measurement beam B1 may be directed to the object S via the QWP 36. The QWP 36 may be introduced when measuring linear birefringence, in order to change the state of polarisation of the beams, thus changing the measured basis. The QWP 36 may be introduced before the DMD, 30 being optional in both cases.

The method 50 then comprises detecting, at block 54, polarization properties of a) the first measurement beam B1′ after interaction with the object S; and b) the first measurement beam B1 without interacting with the object, viz. first reference beam R1. In particular, the method 50 comprises detecting and measuring the intensities of the measurement beam B1′ and the first reference beam R1 with the CCD 15. The method 50 may comprise directing the first measurement beam B1′ to the CCD 15 after interacting with the object S via the second Fourier or suitable lensing/focussing system 40. Moreover, the method 50 comprises directing the first measurement beam B1′ to the CCD 15 after interacting with the object S via the linear polariser 38. The method 50 may comprise directing the first reference beam R1 to the CCD 15 or to another reference CCD 115 via a suitable lens arrangement 104 as is the case in the system 100. In the latter example embodiment, the method 50 may comprise splitting the first measurement beam B1 with a beam splitter 102 into i) the measurement beam B1 which intersects with the sample S; and ii) the first reference beam R1 which does not intersect with the sample S, the intensities of both beams being measured by way of the detector arrangement 14.

The detected polarisation properties of the first measurement beam B1′ and first reference beam R1 may be first polarization measurement and first reference values in the form of first polarisation intensities and first reference intensities detected or measured by the CCD 15. These intensities, values and/or data may be stored in the memory device 18, at block 56.

The method 50 determines, at block 58, if the minimum predetermined number of iterations of measurement beams or measurements has been reached. The Inventors have found that a minimum of thirty measurements is required for the purposes of determining the birefringence of the sample S. In this regard, it will be noted that a minimum of thirty measurement beams, and their associated reference beams, each with their state of polarisation rotated, is generated and used in the process described herein to determine the birefringence of the sample S.

If the number of iterations of measurements recorded by the CCD is less than thirty, the method 50 comprises rotating the state of polarisation of the measurement beam from the immediately preceding measurement beam generated. Where the immediately preceding measurement beam is B1 the method comprises, at block 60, rotating the state of polarisation of the measurement beam to generate a second measurement beam B2 and a second reference beam R2, at block 52, by controlling the DMD 30 to automatically switch from the first hologram to the second hologram, wherein the second hologram is configured to rotate the polarisation state of the beams in the paths X and Y incident on the DMD 30. Thus, it is possible to rotate the polarisation state of the measurement beam B without mechanically moving parts and simply changing the hologram addressing the DMD 30. The second hologram may have a different phase as compared to the first hologram to this end. The second reference beam R2 is generated in the same way as the reference beam R1 as described herein. Further measurement beams Bn are generated in a similar fashion with the state of polarisation being rotated from the preceding measurement beam Bn−1 generated. This may be repeated for thirty iterations.

The processor 16 may be communicatively coupled to other electronic components described herein to control the same. For example, configured to control the DMD 30 to switch the holograms addressed thereto. In this regard, the processor 16 may be configured to control the DMD 30 to automatically switch to the second hologram from the first hologram, and subsequent holograms from a preceding hologram after a predetermined period of approximately one second, or less. This fast switching of the hologram advantageously enables quick rotation of the state of polarisation of the measurement beam B with little to no calibration of the system in doing so.

For the first iteration, the method 50 comprises detecting, at block 54, polarization properties of a) the second measurement beam B2′ after interaction with the object S; and b) the second measurement beam B2 without interacting with the object, viz. second reference beam R2 in a similar fashion as described above with respect to the first measurement beam B1′ and reference beam R1. In particular, the method 50 comprises detecting and measuring second polarisation intensities of i) the second measurement beam B2′; and ii) the second reference beam R2 by the CCD 15. These intensities, or values and/or data associated therewith may be stored in the memory device 18, at block 56.

The methodology described above thus far may be repeated until the predetermined minimum number of iterations of rotating the state of polarisation, beam generation and measurements are at least 30, at block 58.

Once the number of iterations of measurements are equal to thirty, the method 50 comprises using, at block 62: a) the detected polarization properties of the first, second, and subsequent measurement beams B1′, B2′, Bn′ (not shown) after interaction with the object, in other words the first, second, and subsequent polarisation intensities or values; and b) the polarization properties of the first, second, and subsequent reference beams R1, R2, and Rn in other words the first, second, and subsequent reference polarisation intensities or values to determine a measurement of birefringence the object S. In particular, the processor 16 is configured to use the first, second, and subsequent polarisation intensities to determine the linear retardation 6 or optical rotation angle x of the object S by fitting the measured intensities to Eqns. 8 and 7 as described above.

Referring also to FIG. 5 of the drawings, a plot of the reference polarisation intensities detected/measured by the CCD 15 is indicated by reference numeral 70 and has a cosine profile. Similarly, a plot of measured polarisation intensities detected/measured by the CCD 15 is indicated by reference numeral 72. As can be seen in the plot, four iterations of measurements at i, ii, iii, and iv correspond to four measurement beams and reference beams being used to generate the plots. The observable shift in the cosine like curves of the measurement beams going through the sample S 72 and their associated reference beams 70 is used to determine the birefringence of the sample S. It will be appreciated by those of reasonable skill in the art that the shift in the cosine-like curve corresponds directly to the linear birefringence and twice of the circular birefringence. The beforementioned are measured in units of radians and can be translated to other quantities via the material properties, including the refractive index for analyzed wavelength and length travelled inside the material.

Those skilled in the art will recognise that the plots 70, 72 and/or the data associated with the same, i.e., the intensity values of the measurement beams with different polarisation states going through the object and their associated reference intensity values may be used with suitable curve matching algorithms to enable a determination of the birefringence of the sample S.

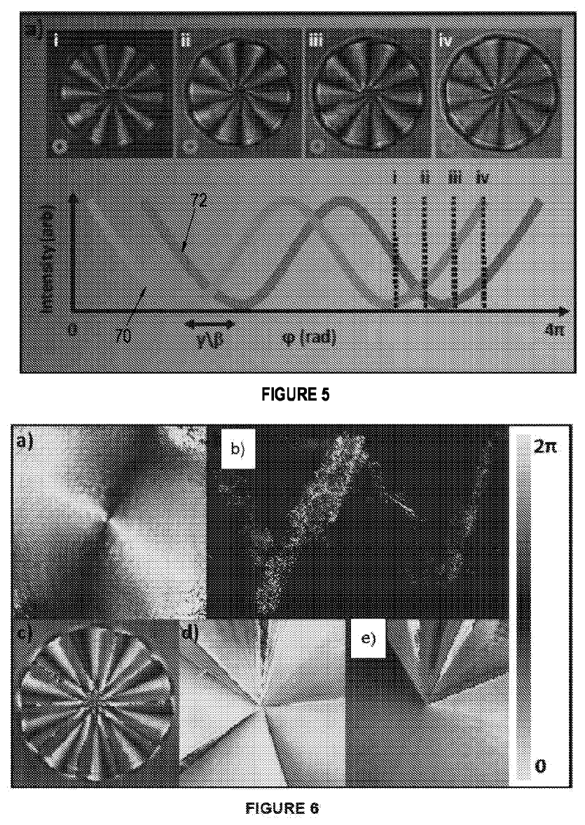

Referring to FIG. 6 of the drawings, the above system 10 and method 50 were employed by way of example with the following circularly birefringent samples: a liquid crystal (LC) q-plate (q=½), which induces a phase difference β between the right- and left-circularly polarized components by imparting equal and opposite geometric phases to these components; and L-alanine crystals (adhered to a glass slide with paratone oil) which impart the phase difference V due to the presence of a chiral center in the molecules.

The results showing the measured B for the LC q-plate are shown in FIG. 5 a), the obtained measurement agrees with what is expected from a q=½ LC q-plate within the CCD 15 resolution.

The results for the alanine crystals can be seen in FIG. 5 b)-here the crystals were arranged in the shape of a ‘W’. These crystals, of the P2₁2₁2₁ symmetry group exhibit different chiral structures in the propagation direction depending on the orientation of the sample, so crystals orientated differently will show different values for birefringence. Comparing the measured β it is possible to see that the first anti-diagonal crystal (from left to right) has an observed chiral structure with handedness opposite to the first diagonal crystal.

The linearly birefringent samples used were: a metasurface q-plate (l=5) and metasurface j-plates (l_{H}=6, l_{V}=5 and l_{H}=5, l_{V}=10). These metasurfaces are comprised of subwavelength TiO₂ posts on a SiO₂ substrate, where the spatially varying rectangular width dimensions are used to impart independent phases to the horizontally and vertically polarised components of light passing through.

The results for the metasurface q-plate agree with that expected of an element attemption to impart l=±5 OAM to the horizontal and vertical polarization components. The j-plate results clearly display partial phase ramps with correspond to the independent OAM's introduced to the horizontal and vertical polarization components.

In view of the foregoing, by changing the input polarization state impinging on a medium that gives different phases to each polarization component (birefringent) one can, after a projection into a fixed polarization direction, utilize a phase-shifting polarimetry technique to measure the birefringence in each pixel of the image projected in the camera. Since the analysis is at a fixed analyzer angle, the reference for the phase-shifting method can be taken directly from the measurement pictures, or a copy of it can be used by putting a beamsplitter right before the sample. The measurement process can reach extremely fast speeds, being limited by the frame rate of both the DMD and the camera, which in this case is in the order of kHz and 30 fps respectively. The data analysis is only limited by the processing power of the hardware used.

Unlike other apparatuses, the present disclosure does not use mechanically moving parts in the setup, being ideal for automation. Similar setups that have no moving parts often use birefringent materials to rotate polarization, being very calibration sensitive unlike the present disclosure wherein the DMD is controlled digitally, and the polarization rotation is based on holographic methods. Moreover, all of the optical components employed herein have been used extensively in both academia and industry, attesting its possible durability.

The systems and methods disclosed herein provide a robust and simple setup able to measure birefringence in materials with spatial resolution in extremely fast speeds. The system can perform polarimetry or act as a digitally controlled polariscope. The spatial resolution is directly related to the imaging system, enabling this method to be used in a wide range of scales.

1. A method for measuring an optical characteristic of an object, wherein the method comprises:
directing a uniformly polarised measurement beam onto an object;
rotating the state of polarisation of the measurement beam with holograms;
detecting polarisation properties of the measurement beam without interacting with the object and after interacting with the object for each state of polarisation of the measurement beam; and
using the detected polarization properties of the measurement beam without interacting with the object and after interacting with the object for each the state of polarisation to determine a measurement of at least one optical characteristic of the object.

2. The method as claimed in claim 1, wherein the method comprises generating the uniformly polarised measurement beam.

3. The method as claimed in either claim 1 or 2, wherein the measurement beam without interacting with the object is a reference beam.

4. The method as claimed in claim 3, wherein the method comprises splitting a uniformly polarised beam into two identical beams, wherein one of the beams is the measurement beam which is directed onto the object and the other is the reference beam.

5. The method as claimed in any one of the preceding claims, wherein the method comprises rotating the state of polarisation of the measurement beam a plurality of times by way of a corresponding number of holograms.

6. The method as claimed in claim 5, wherein method comprises automatically rotating the state of polarisation of the measurement beam, from an immediately preceding measurement beam, a plurality of times by way of holograms provided by way of a digitally controlled phase/polarisation sensitive device.

7. The method as claimed in claim 6, wherein the digitally controlled phase/polarisation sensitive device is a Digital Micromirror Device (DMD).

8. The method as claimed in claim 6, wherein the plurality of times is not less than thirty.

9. The method as claimed in any one of the preceding claims, wherein the at least one optical characteristic of the object measured is birefringence.

10. The method as claimed in any one of the preceding claims, wherein the each of the holograms is configured to interact with a pair of incident light beams to produce the uniformly polarised measurement beam having a predetermined polarisation state.

11. The method as claimed in any one of the preceding claims, wherein each of the holograms comprise at least two holograms superimposed and arranged to interact with incident light beams to produce the uniformly polarised measurement beam.

12. The method as claimed in any one of the preceding claims, wherein the method comprises:
detecting the polarisation properties of the measurement beams after interacting with the object to generate polarization measurement values, wherein the polarization measurement values represent output polarization states of the measurement beams, after interacting with the object; and
detecting the polarisation properties of the measurement beams without interacting with the object to generate polarization reference values, wherein the polarization reference values represent output polarization states of the measurement beams without interacting with the object.

13. The method as claimed in claim 12, wherein the method comprises using the polarization measurement values and polarization reference values to determine at least one birefringence parameter representing the birefringence of the object, wherein the birefringence parameter is representative of an amount of birefringence of the object.

14. The method as claimed in claim 13, wherein the method comprises determining the birefringence parameter through numerical fitting with minimal error using the polarisation measurement values and polarisation reference values.

15. The method as claimed in any one of claims 12 to 14, wherein the method comprises detecting the polarisation properties of the measurement beams with at least one suitable photodetector device having a plurality of pixels, wherein the polarisation measurement values and/or polarisation reference values are associated with intensity values for each pixel in an image captured by the photodetector device.

16. The method as claimed in any one of the preceding claims, wherein the method comprises:
splitting a light beam from a light source into two paths with differently polarised beams travelling in the two paths;
providing the holograms to interact with the two paths, wherein each of the holograms comprise a hologram which interacts with one polarised beam, and another superimposed hologram which interacts with the other differently polarised beam thereby to modulate both differently polarised beams to make first diffraction orders of both polarised beams with uniform polarisation come out of the hologram together to be used as the measurement beam.

17. The method as claimed in claim 16, wherein the differently polarised beams travelling in the two paths are vertically and horizontally polarised light beams, respectively travelling in the two paths which interact with the holograms to yield the uniformly polarised measurement beams, respectively.

18. The method as claimed in either claim 16 or 17, wherein the light source is a laser, wherein the method comprises expanding and collimating the light beam from the laser prior to splitting the same into the two paths.

19. The method as claimed in any one of the preceding claims, wherein the method comprises directing the measurement beams through a first polarising element prior to interacting with the object.

20. The method as claimed in claim 19, wherein the first polarising element is a quarter wave plate.

21. The method as claimed in any one of the preceding claims, wherein the method comprises directing the measurement beams through a second polarising element after interacting with the object.

22. The method as claimed in claim 21, wherein the polarising element is in the form of a linear polariser, a polarizing beam splitter, or a Wollaston Prism.

23. The method as claimed in any one of the preceding claims, wherein the method comprises storing the detected polarization properties associated with the measurement beams without interacting with the object and after interacting with the object in a suitable memory device for processing to determine the measurement of at least one optical characteristic of the object.

24. The method as claimed in any one of the preceding claims, wherein the method comprises directing the measurement beams through one or more Fourier imaging systems before detecting the polarisation properties.

25. A system for measuring an optical characteristic of an object, wherein the system comprises:
a beam generating arrangement comprising a holographic device, wherein the beam generating arrangement is configured to generate and direct a uniformly polarised measurement beam onto an object, wherein the holographic device is configured to rotate a state of polarisation of the measurement beam with holograms;
a detector arrangement configured to detect polarisation properties of the measurement beam without interacting with the object and after interacting with the object for each the state of polarisation of the measurement beam; and
a processor configured to use the detected polarization properties of the measurement beams without interacting with the object and after interacting with the object for each state of polarisation of the measurement beams to determine a measurement of at least one optical characteristic of the object.

26. The system as claimed in claim 25, wherein the beam generating arrangement is configured to generate a uniformly polarised initial measurement beam having an initial polarisation state; and generate a plurality of uniformly polarised subsequent measurement beams having subsequent polarisation states by way of holograms provided by the holographic device, wherein each subsequent polarisation state is rotated from an immediately preceding polarisation state by way of the holograms.

27. The system as claimed in either claim 25 or 26, wherein the detector arrangement comprises a photosensitive detector device configured to detect polarization properties of the measurement beams without interacting with the object and after interacting with the object.

28. The system as claimed in any one of claims 25 to 27, wherein the processor is configured to use the detected polarization properties of the initial and subsequent measurement beams without interacting with the object and after interacting with the object to determine the measurement of at least one optical characteristic of the object.

29. The system as claimed in any one of claims 25 to 28, wherein each hologram provided by the holographic device comprises two superimposed holograms and is arranged to interact with incident light beams to produce the uniformly polarised measurement beam having a predetermined polarisation state.

30. The system as claimed in any one of the preceding claims, wherein the beam generating arrangement comprises a light source in the form of a laser light source.

31. The system as claimed in any one of claims 25 to 30, wherein the holographic device is configured to provide the holograms to interact with incident light beams from a light source to generate the measurement beams in a computer-controlled/electronic/digital fashion.

32. The system as claimed in any one of claims 25 to 31, wherein the holographic device is a Digital Micromirror Device (DMD).

33. The system as claimed in any one of claims 25 to 32, wherein the detector arrangement is configured to:
detect the polarisation properties of the measurement beams after interaction with the object to generate polarization measurement values, wherein the polarization measurement values represent output polarization states of the measurement beams after interaction with the object; and
detect the polarisation properties of the measurement beams without interacting with the object to generate polarization reference values, wherein the polarization reference values represent output polarization states of the measurement beams without interacting with the object.

34. The system as claimed in claim 33, wherein detector arrangement comprises a reference detector configured to detect the polarisation properties of the measurement beams without interacting with the object in order to generate the polarisation reference values.

35. The system as claimed in claim 34, wherein the system comprises a suitable beam splitting arrangement configured to split the measurement beam into two paths, one directed to intersect with the object and detector, and the other direct to the reference detector.

36. The system as claimed in any one of claims 25 to 35, wherein the optical characteristic of the object being measured is birefringence of the object.

37. The system as claimed in any one of claims 33 to 35, wherein the processor is configured to use the polarization measurement and the polarization reference values, to determine at least one birefringence parameter representing the birefringence of the object.

38. The system as claimed in any one of claims 25 to 37, wherein the beam generating arrangement comprises a suitable beam splitter to split the light beam from a light source into two paths, wherein the light beams travelling in the two paths are differently polarised beams or have two different polarisation components.

39. The system as claimed in claim 38, wherein the holographic device is located downstream from the light source and intersects with the two paths so that the light beams travelling in the two paths both intersect the holographic device.

40. The system as claimed in either claim 38 or claim 39, wherein the two paths intersect at the holographic device with an angle therebetween.

41. The system as claimed in claim 40, wherein the angle is approximately 1.5°.

42. The system as claimed in any one of claims 38 to 41, wherein each hologram comprises a hologram which interacts with one polarised beam, and another superimposed hologram which interacts with the other differently polarised beam thereby to modulate both polarised beams to make first diffraction orders of both polarised beams come out of the hologram together with uniform polarisation.

43. The system as claimed in any one of claims 38 to 42, wherein the beams arriving at the holographic device are vertically and horizontally polarised light beams travelling in the two paths which interact with the holograms provided by the holographic device to yield the uniformly polarised measurement beams.

44. The system as claimed in any one of claims 25 to 43, wherein the system comprises a suitable aperture to spatially filter the measurement beams from the holographic device.

45. The system as claimed in any one of claims 38 to 43, wherein the beam generating arrangement comprises suitable optical components to expand and collimate the light beam from the light source prior to splitting the same into the two paths.

46. The system as claimed in any one of claims 25 to 45, wherein the system comprises a first polarising element located downstream from the holographic device and upstream from the object.

47. The system as claimed in claim 46, wherein the polarising element is in the form of a quarter wave plate.

48. The system as claimed in any one of claims 25 to 47, wherein the system comprises a second polarising element located downstream from the object.

49. The system as claimed in claim 48, wherein the polarising element is in the form of a linear polariser, a polarizing beam splitter, or a Wollaston Prism.

50. The system as claimed in any one of claims 25 to 49, wherein the system comprise a suitable memory device configured to store the detected polarization properties associated with the measurement beams in a suitable memory device for processing to determine the measurement of at least one optical characteristic of the object.

51. A method for measuring an optical characteristic of an object, wherein the method comprises:
a) generating a uniformly polarised initial measurement beam having an initial polarisation state;
b) directing the initial measurement beam onto an object;
c) detecting polarization properties of the initial measurement beam without interacting with the object and after interacting with the object;
d) generating a uniformly polarised subsequent/second measurement beam having a subsequent polarisation state by way of a hologram, wherein the subsequent polarisation state is rotated from the initial polarisation state and/or any preceding polarisation state of the measurement beam by way of the hologram;
e) directing the subsequent measurement beam onto the object;
f) detecting polarization properties of the subsequent measurement beam without interacting with the object and after interacting with the object;
g) repeating steps d) to f) for a predetermined number of times; and
h) using the detected polarization properties of the initial and subsequent/second measurement beams without interacting with the object and after interacting with the object to determine a measurement of at least one optical characteristic of the object.
